(19) United States
(12) Patent Application Publication
(10) Pub. No.: US 2001/0045049 A1
(43) Pub. Date: Nov. 29, 2001

(54) Fishing depth finder/apparatus with torsion bar clip

(76) Inventor: Brian David Jopp, Eden Prairie, MN (US)

Correspondence Address: Brian David Jopp, Apartment 119, 13775 Chestnut Drive, Eden Prairie, MN, 55344, US

(21) Appl. No.: 09/765,508

(22) Filed: Jan. 19, 2001

Related U.S. Application Data
(60) Provisional application No. 60/177,110, filed on Jan. 20, 2000.

(51) Int. Cl. A01K 91/00

(52) U.S. Cl. 43/43.1

(57) ABSTRACT

A device for finding the depth of a lake, river, or pond. The device has been made so the angler can attach the depth finder to the line while the hook is already submerged. The depth finder can be attached to any cross section of the line. The depth finder consists of a weight and a torsion bar clip. The new invention utilizes the torsion bar clip function to make a slip connection to the fishing line, where the depth finder can slide vertically upon an angler's line.

A torsion bar clip permits the angler to attach the depth finder to the line in a slip connection. The torsion bar clip opens at the opposite end of the weight by squeezing two torsion bars together, which in turn, lifts two ring-like objects apart. While force is being applied, the line can be slipped inside of both rings. When force is withdrawn, the rings close and the line is surrounded by the walls of the rings. The depth finder can be placed anywhere on the line and it will descend to the eyelet of the hook, sinker, or other obstacle. The depth finder does not require the angler to pull up the line until the depth is set. Also, the depth finder does not break away from the hook, as does the prior art or popular depth finder with the clothes pin type of attachment.

In addition, the torsion bar clip has multiple uses when attached to other fishing applications: the torsion bar clip could be attached to sinkers, tackle, spinners, bobbers, down riggers, and other fishing apparatus. When attached to other fishing apparatus, various other new techniques in fishing ought to be created due to its unique connective feature. For example, an angler would not have to cut the line to set up a slip bobber. Instead, if the slip bobber has the torsion bar clip attached to it, the angler merely needs to compress the torsion bars and fit the line into the integral loop. When the angler wants to change back to another fishing application, just reverse the process.

### CROSS REFERENCES

This application claims the benefit of Provisional Patent Application Ser. No. 60/177,110 filed Jan. 20, 2000.

### BACKGROUND

1. Field of Investigation

This invention relates to fishing; specifically, it is an improved connection for a depth finder, sinker or other fishing apparatus.

2. Description of Prior Art

The conventional depth finder utilizes a weight and a clothespin type of connection. The conventional depth finder requires the line to be raised to add the weight. The conventional depth finder, upon contact with the bottom of the lake will, at times, unclamp. The conventional depth finder uses more steel or like-material to make the connective part of the product. The depth finder requires the angler to crimp it onto the hook. If there is bait on the hook, many times it kills or seriously injures the bait.

With the conventional depth finder, time is wasted from raising the line and having to replace the bait. Furthermore, if it does unclamp, then the angler needs to raise the line again wasting even more time. If the angler does not have any more depth finders with him/her, then it becomes even more difficult and now angler has wasted a significant amount of time and money from the losses. Furthermore, the depth finder pollutes the lake. Usually these are made out of lead. Increasingly, lead becomes a greater concern to the environment and especially lakes.

### SUMMARY INCLUDING OBJECTS AND ADVANTAGES

A device to find depth or add weight to a fishing line that consists of two parts: a bell type weight and a torsion bar clip. The angler pinches the torsion bars together and slips the line in between the opening. Next, the angler permits the torsion bars to go back to their natural state. The line is now fixed within the loop. Now the angler can drop the depth finder from the surface, to the lure, at any given depth. The depth finder will continue until it reaches the bottom. At this point, the angler can set his/her bobber at the right depth by subtracting the desired length from the maximum depth given. Also, the conventional depth finder with the clothes pin type of connection is limited to just depth finders. It is not used in any other application in fishing.

### OBJECTS AND ADVANTAGES

The ability to place depth finder on a line after the lure is already submerged will save time for the angler. The changed use for the torsion bar clip, when fastened correctly, will ensure that the depth finder will not be lost upon contact with the bottom of the lake. Both of the above advantages will save time and money for the angler, which will result in greater opportunity to catch fish.

The prior art that was constructed with a clothes pin type of connection, would at times, upon contact with the bottom of the lake, come loose from the lure and would be lost. When this occurs the angler loses money and has to pull the line up and attach another depth finder to the lure: lost time.

The new depth finder can be placed on any cross section of the fishing line. Being so, the line does not need to be raised to check depth. This saves the angler time. With the unique torsion bar clip connection, the new depth finder will not come off after contact with the bottom of the lake: saves time, money, does not pollute lake, greater satisfaction, and greater odds to catch fish. Also, the depth finder does not require a spare because it does not come off the line once attached correctly.

The new depth finder uses less material and takes up less room to manufacture the connective device, so it is more efficient to produce and ship.

The connective device or torsion bar clip does not restrict itself to a depth finder. The torsion bar clip could just as easily carry tackle, sinkers, spinners, hooks, and other fishing apparatus. For example, when fishing white fish, it is a popular technique to shine the fish with a spinner. Usually this means that the angler would use one pole just for the spinner. Now, with the torsion bar clip connected to a spinner, the angler could place the teardrop (hook) at a chosen depth. Then, the angler could connect spinners, drop them down the length of the line. Thereby, the angler will have better odds of attracting and catching more fish.

Likewise, there is much potential for new techniques of fishing to be created. For example, many times the fish will hit the bait, tackle, or hook while it is falling to the lowest point. If the torsion bar clip has a hook attached to it, and the fish are striking the bait and hook prior to it reaching the maximum point on the line, then the angler could attach and drop the above torsion bar connection and hook. This would result in more fish being caught.

Also, since there are more uses than just being a depth finder, the manufacturing costs would be reduced because more could be made at one time.

Also, it should be noted that the new torsion bar clip, opposed to U.S. Pat. No. 5,042,191, has several modifications that make it far superior to this invention: The torsion bar has been extended so that there is more room for fingers and the angler to manipulate the torsion bar itself. In addition, the torsion bars have handles (a wave, curve, or semi-circle) bent into them, so that the clip does not twist when being compressed.

Instead, the angler can easily place pressure on the torsion bars to control the opening. The connection to the fish line has been altered. Two advantages spring from inverting the use of the integral opening: the torsion bar clip and apparatus can slide on the line, and the torsion bar clip can be removed or added without breaking or tying the line. Also, at the point where the line was tied on the above patent, an extended tail was bent in to provide an area for it to fit into a mold or carry other fishing apparatus.

### BRIEF DESCRIPTION OF THE DRAWINGS

FIG. 1A shows a torsion bar clip while compressed revealing the integral loop in the open position.

FIG. 1B shows the torsion bar clip while it rests in its natural state with the integral loop in a closed position.

FIG. 1C is a side view of the torsion bar clip.

FIG. 1D is a top view of the torsion bar clip revealing a handle.

FIG. 2 is a blown-up diagram of the caste weight in a bell type mold and a torsion bar clip.

FIG. 3 is an O.G. drawing revealing the weight with the torsion bar clip molded in place.

### REFERENCE NUMERALS

1. Integral loop opened position

2. Torsion bar handles

3. Bend

4. Curve

5. Tail

6. Spur

7. Integral loop closed position

### PREFERRED EMBODIMENT—DESCRIPTION

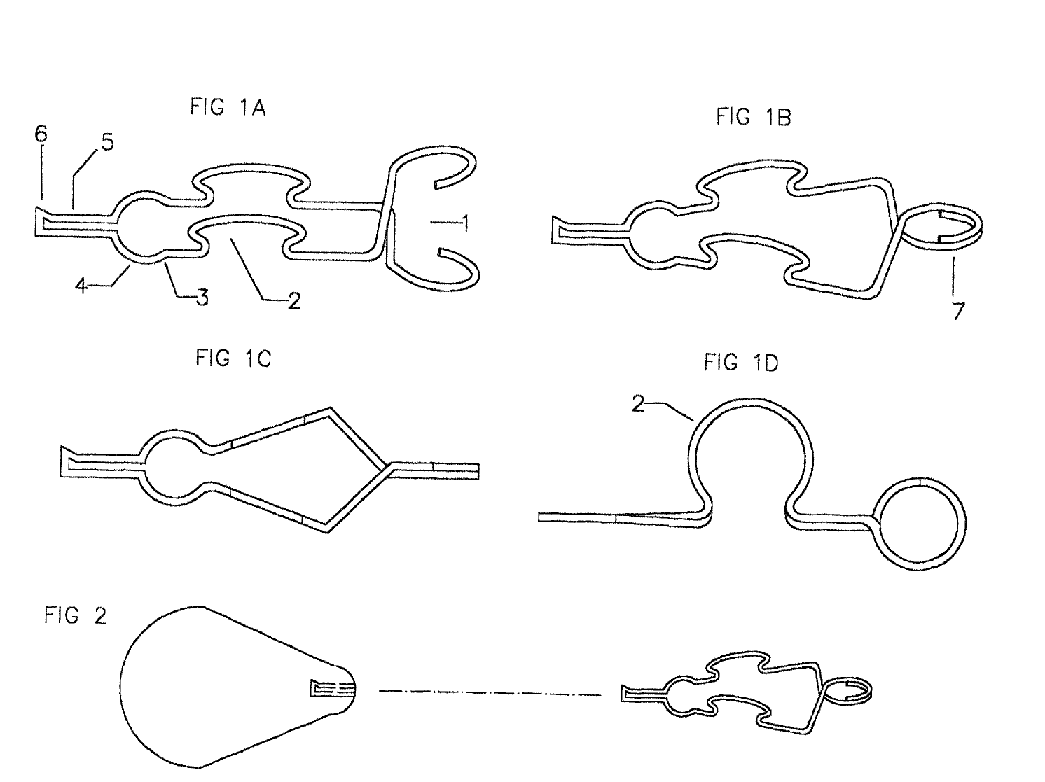

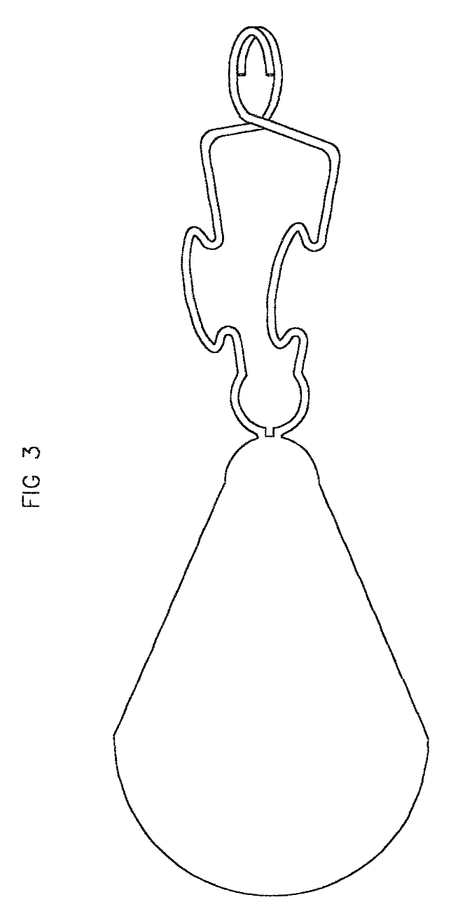

As shown in FIG. 2, the depth finder is made up of two parts: the weight end and the torsion bar clip. As seen in FIG. 1A and FIG. 1B, the torsion bar is a continuous bend with the ends ending at the integral loop (7). This material to be bent needs to be spring-type of wire, so that the operational function for controlling the integral loop can exist. In FIG. 1A, the torsion bars are compressed. It can be seen that while compressed, the integral loop opens (1). Basically, the torsion bar clip consists of two torsion bars with handles (2), a bend (3) to spring off of, a curve (4) to counteract the loop (7), the loop itself (7), and a tail (5) with a spur (4). The torsion bars are curved and waved with handles that are perpendicular to the rest of the bar (Compare FIG. 1C with FIG. 1D). These handles (2) give balance to the torsion bar clip so that it will not pivot when being compressed. The tail (5) and spur (6) have been bent into the torsion bar clip so that they can fit into a mold, or have an addition fishing apparatus attached to it. The spur ensures that the torsion bar clip will not come loose from the caste part (FIG. 2), and the spur provides more room for other possible attachments such as a split ring. As mentioned the bend (3) and curve (4) add the spring quality to bring the integral loop (7) to a closed position (FIG. 1B).

### PREFERRED EMBODIMENT—OPERATION

In FIG. 1B a torsion bar clip is shown while it is not being compressed. The main operation concerning the angler is to compress the handles (2). While compressed, as shown in FIG. 1A, the integral loop opens (1). While keeping the torsion bars compressed, the angler slips the line through the opening. After the line is centered inside of the integral loop, pressure is relieved from the torsion bars until the integral loop is in a closed position (7). Now, the line is in an axial position with the integral loop. The angler now pulls the line until it touches the arch opposite of the tail, places the torsion bar clip and attached fishing apparatus into the water, and releases. The device will move downward until it rests upon an obstacle such as a lure, sinker, bobber stop, or other fishing apparatus. At this point, if the apparatus is a depth finder with the weight being denser than the buoyancy of the bobber will continue to pull the lure, line, and or bobber until it reaches the bottom of the lake. The line at the surface will become limp upon reaching the bottom. So, the angler slowly pulls up on the line until the depth finder can be felt and the line tightens; this is the maximum depth. Now, the angler can set the bobber at the desired depth by subtracting the desired length from the maximum depth given. To remove the torsion bar clip and apparatus, the angler pulls the device to the surface and reverses the process.

### CONCLUSION, RAMIFICATIONS, AND SCOPE

Thus the reader will see that the torsion bar clip attached to a caste weight (depth finder) with its unique connective system saves the angler time and money, both of which contribute to more satisfaction and increased odds for catching fish. Also, it does not pollute the lake because it does not fall off after hitting the bottom.

While my above description contains many specificities, these should not be construed as limitations on the scope of the invention, but rather as an exemplification of one preferred embodiment thereof. Many other variations are possible. For example, when fishing white fish, it is a popular technique to shine the fish with a spinner. Usually this means that the angler would use one pole just for the spinner. Now, with the torsion bar clip connected to a spinner, the angler could place the teardrop (hook) at a chosen depth. Then, the angler could connect spinners, drop them down the length of the line, and attract more fish to the area. Thereby, the angler increases the odds to catch more fish. Some other things to connect with the torsion bar clip are as follows: sinkers, tackle, bobbers, spinners or other attractions, down riggers, and nearly any type of fishing apparatus could be attached to the torsion bar clip. Furthermore, the color of the torsion bar clip and apparatus could be varied. Also, depending on choice of the angler, the size of the clip and its apparatus should be only limited to size chosen. For example, a deep-sea angler may require a much larger torsion bar clip than a fresh water angler who seeks only pan fish. In another example, an angler would not have to cut the line to set up a slip bobber. Instead, if the slip bobber has the torsion bar clip attached to it, the angler merely needs to compress the torsion bars and fit the line into the integral loop. When the angler wants to change back to another fishing application, just reverse the process.

Accordingly, the scope of the invention should be determined not by the embodiment(s) illustrated, but by the appended claims and their legal equivalents.

What is claimed is:

1. A method of axial positioning of a torsion bar clip and apparatus with sliding characteristic onto a fishing line, comprising the steps of:
(a) exposing a cross section of fish line,
(b) exerting energy on the torsion bar handles to open the integral loop,
(c) whereby, an opening in the torsion bar clip is operational and open,
(d) maneuvering said torsion bar clip's integral opening so that said fishing line is positioned in the center of said integral opening,
(e) releasing said energy so that said integral opening encloses said line,
whereby, said fishing apparatus is now in an axial position to slide along the length of the said fishing line.

2. A device for axial positioning of a torsion bar clip and apparatus with sliding characteristic onto a fishing line comprising:
(a) a device having an axial characteristic to be positioned on any cross section of a fishing line,
(b) a device, having torsion bars with spring ability,
(c) a device, having a controllable integral opening,
(1) an opening, large enough to permit the fishing line to pass into center of opening and large enough to permit device to slide on fishing line and
(2) an opening, having characteristics to conceal the fishing line in-between loops once closed,
whereby, the device has the ability to be placed on fishing line at any cross section,
whereby, the device can slide freely along the fishing line length.
